(19) United States
(12) Patent Application Publication
(10) Pub. No.: US 2005/0248518 A1
(43) Pub. Date: Nov. 10, 2005

(54) Image display device and light source unit therefor

(76) Inventors: Futoshi Yamasaki, Yokohama (JP); Masahiko Yatsu, Fujisawa (JP)

Correspondence Address: MCDERMOTT WILL & EMERY LLP, 600 13TH STREET, N.W., WASHINGTON, DC, 20005-3096, US

(21) Appl. No.: 11/109,870

(22) Filed: Apr. 20, 2005

(30) Foreign Application Priority Data
Apr. 22, 2004 (JP) 2004-126715

(51) Int. Cl. G09G 3/34

(52) U.S. Cl. 345/84

(57) ABSTRACT

A bright image with smooth grayscale is ensured. Semiconductor light emitting devices that separately emit red, green, and blue light are used as a light source. The peak values of power needed to cause the semiconductor light emitting devices to emit light are varied according to image grayscale during the period of one cycle of screen display.

### CLAIM OF PRIORITY

The present application claims priority from Japanese application serial no. P2004-126715, filed on Apr. 22, 2004, the content of which is hereby incorporated by reference into this application.

### BACKGROUND OF THE INVENTION

The present invention relates to an image display technique by which light from a light source is directed to an image display element to form an optical image for display, and in particular, to a technique for grayscale display.

Conventional techniques related to the present invention have been disclosed in Japanese Patent Laid-open Nos. 2004-37958 and 2003-186110, for example. In Japanese Patent Laid-open No. 2004-37958, semiconductor light emitting devices (LEDs) for emitting different monochromatic light are used as a light source and a digital micro mirror device (DMD) as an image display element, thereby operating the LEDs sequentially with time sharing in synchronization with a video signal. In Japanese Patent Laid-open No. 2003-186110, red, green, and blue light emitting diodes are used as a light source and a DMD panel are used as an image display element, thereby displaying color images by synchronizing red, green, and blue ON/OFF signals of the light emitting diodes with ON/OFF signals of pixels of the DMD (trademark of Texas Instruments).

### SUMMARY OF THE INVENTION

In the conventional techniques mentioned above, it is difficult to provide smooth grayscale on a low-grayscale image, and brightness may be lost on a bright-grayscale image.

In view of the forgoing, the problem of the present invention is to enable smooth grayscale display on a low-grayscale image and suppress the loss of brightness on a bright-grayscale image.

An object of the present invention is to provide an image display technique with higher picture quality by solving the above problems.

To solve the above problem, according to the present invention, an image display device for forming an optical image according to a video signal by directing light from a light source side to image display elements, and its light source unit are configured such that semiconductor emitting elements that separately emitting red, green and blue light are used as light sources and the peak values of light emitting power of the semiconductor light emitting devices are varied according to image grayscale during the period of one cycle of screen display.

The image display device according to the present invention can provide a bright image having smooth grayscale.

### BRIEF DESCRIPTION OF THE DRAWINGS

FIG. 1 shows a configuration of an image display device according to an embodiment of the present invention;

FIG. 2 shows a first waveform of power driving a LED in a light source for the device shown in FIG. 1;

FIG. 3 shows a second waveform of power driving the LED in the light source for the device shown in FIG. 1;

FIG. 4 shows a third waveform of power driving the LED in the light source for the device shown in FIG. 1;

FIG. 5 shows a fourth waveform of power driving the LED in the light source for the device shown in FIG. 1;

FIG. 6 shows a fifth waveform of power driving the LED in the light source for the device shown in FIG. 1; and

FIG. 7 shows a sixth waveform of power driving the LED in the light source for the device shown in FIG. 1.

### DETAILED DESCRIPTION OF THE PREFERRED EMBODIMENTS

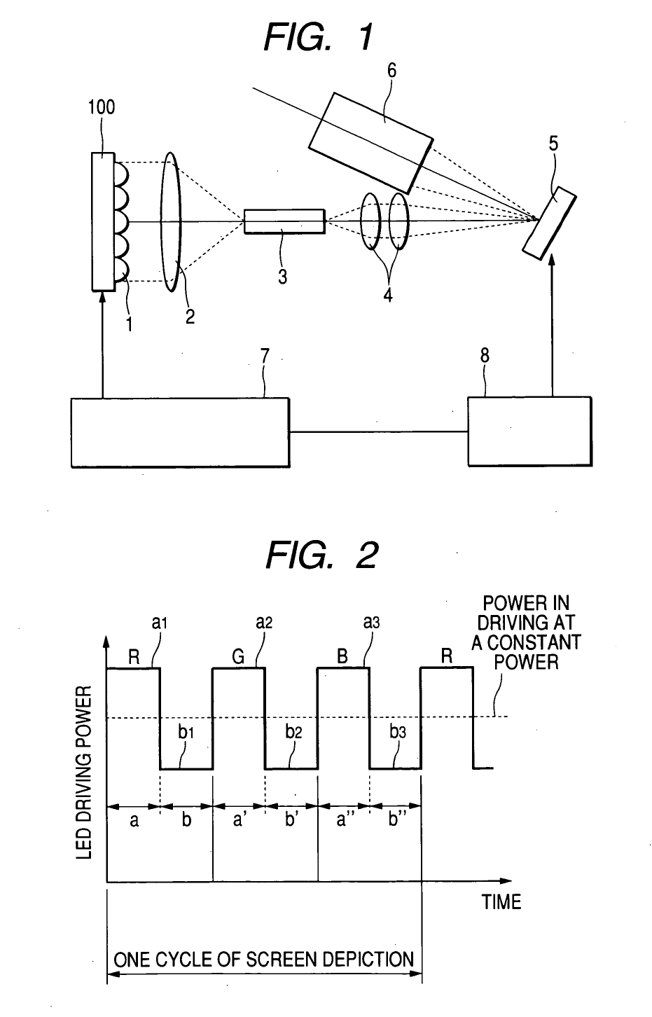

The best mode for carrying out the present invention is described below with reference to the drawings. FIGS. 1 to 7 are explanatory diagrams of the embodiments of the present invention. FIG. 1 shows a configuration of an image display device according to an embodiment of the present invention. FIGS. 2 to 7 show the examples of waveforms of power driving semiconductor light emitting devices used in the light source of the device illustrated in FIG. 1.

FIG. 1 shows a configuration of a projection-type image display device in which semiconductor light emitting devices are used as a light source. The image display device uses, as an image display element, a digital light processing (DLP) type image display element in which emitted light is modulated through reflection from micro mirrors.

In FIG. 1, reference numeral 1 denotes a semiconductor light emitting device. Reference numeral 100 denotes a light source array comprising a plurality of the semiconductor light emitting devices 1 arranged in one plane and emitting red light (hereinafter referred to as R light), green light (G light), and blue light (B light) with time sharing. Reference numeral 2 denotes a condensing lens; 3 a light valve for equalizing light; 4 an illuminated-light imaging lens; 5 a DLP image display element; 6 a projecting lens unit; 7 a light source driving circuit for driving semiconductor light emitting devices 1 in the light source array 100; and 8 an image display element driving circuit for driving the image display element 5 according to video signals. The light source driving circuit 7 drives the semiconductor light emitting devices 1 of the light source array 100 while varying at least the peak value of the power for emitting light according to image grayscale during one cycle of screen display. The circuit 7 varies at least the peak value of the power for emitting light in synchronization with the drive of the image display element 5 to thereby vary the power needed to cause the devices 1 to emit light. The array 100 and the circuit 7 constitute a light source unit in the projection-type image display device.

In the configuration of FIG. 1, light is emitted from the plurality of the semiconductor light emitting devices 1 of the array 100 with time sharing (P polarized light or S polarized light of polarized R light, G light, and B light; S polarized light is taken here, for example). The light is then condensed by the condensing lens 2, and the condensed light is directed to the DLP image display element 5 through the light valve 3 and the illuminated-light imaging lens 4. The element 5 modulates the directed light through reflection from the micro mirrors corresponding to pixels to form optical images for each of R, G, and B light. The optical image light enters the projecting lens unit 6 for enlargement, and is projected on a screen or the like.

FIG. 2 shows a first waveform of power driving the semiconductor light emitting devices in the light source for the device shown in FIG. 1. The light source driving circuit 7 varies the peak values of R, G, and B light emitting power in the semiconductor light emitting devices according to the image grayscale during the period of one cycle of screen display. For the R light, the variable peak value of the light emitting power is set to a1 in the first half period a and b1 in the second half period b; for the G light, the peak value to a2 in the first half period a′ and b2 in the second half period b′; and for the B light, the peak value to a3 in the first half period a″ and b3 in the second half period b′. With image formation, in a bright grayscale portion of the screen a video signal is written throughout the first and second half periods. In a dark grayscale portion of the screen a video signal is written only when brightness in the second-half period is low. This enables smooth grayscale display. Since the power in the first-half period is set to a level higher than that in constant power driving, brightness is not lost even in a bright grayscale image.

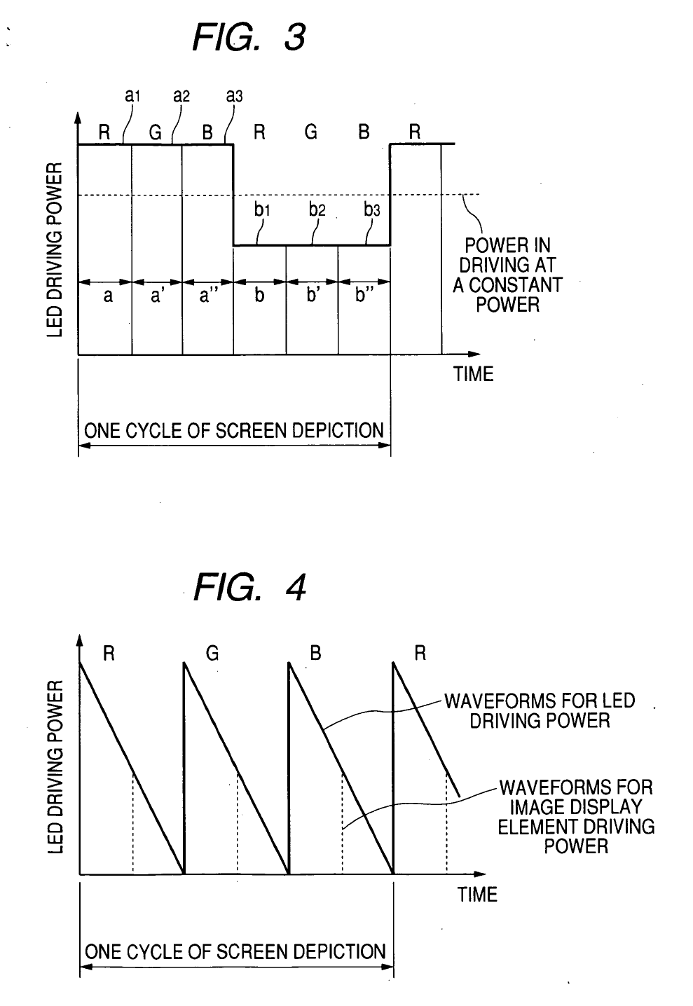

FIG. 3 shows a second waveform of power driving the semiconductor light emitting devices in the light source for the device shown in FIG. 1. The peak values of light emitting power in the semiconductor light emitting devices are varied according to the image grayscale during the period of one cycle of screen display. For the R light, the peak value of the light emitting power is set to a1 in the first half period a and b1 in the second half period b; for the G light, the peak value to a2 in the first half period a′ and b 2 in the second half period b′; and for the B light, the peak value to a3 in the first half period a″ and b3 in the second half period be. However, in the second driving-power waveform the first and the second half period for each of the R, G, and B light are provided not adjacent to each other, that is, apart in time from each other. Driving the semiconductor light emitting devices with the second driving-power waveform also enables smooth grayscale display, and avoiding brightness from being lost.

FIG. 4 shows a third waveform of power driving the semiconductor light emitting devices in the light source for the device shown in FIG. 1. The third driving-power waveform is of a sawtooth. The peak values and durations of the sawtooth waveforms for each of R, G, and B light are varied according to the image grayscale during the period of one cycle of screen display. The waveforms shown in the dotted line in this figure represent driving waveforms for the image display element 5 in a grayscale of about 30%. Driving the semiconductor light emitting devices with the third driving-power waveform also enables smooth grayscale display and avoiding brightness from being lost.

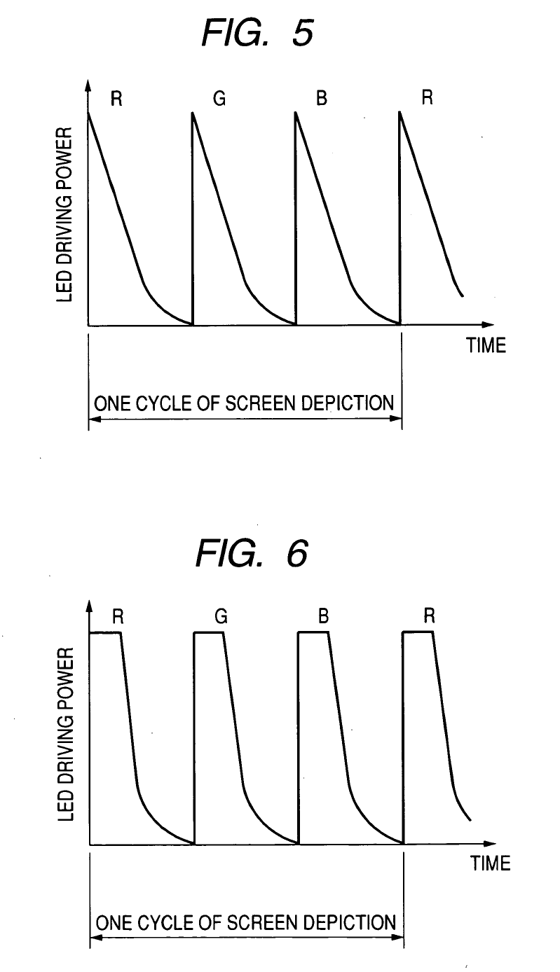

FIG. 5 shows a fourth waveform of power driving the semiconductor light emitting devices in the light source for the device shown in FIG. 1. The fourth power waveform is pointed at its top and spreads at its bottom. The peak values or the peak values and durations of the waveform for each of R, G, and B light are varied according to the image grayscale during the period of one cycle of screen display. Driving the semiconductor light emitting devices with the fourth driving-power waveform also enables smooth grayscale display and avoiding brightness from being lost. In particular, more detailed image display is enabled in dark grayscale.

FIG. 6 shows a fifth waveform of power driving the semiconductor light emitting devices in the light source for the device shown in FIG. 1. The fifth power waveform is saturated at its top and spreads at its bottom. The peak values or the peak values and durations of the waveform for each of R, G, and B light are varied according to the image grayscale during the period of one cycle of screen display. Driving the semiconductor light emitting devices with the fifth driving-power waveform also enables smooth grayscale display and avoiding brightness from being lost. In particular, more detailed image display is enabled in dark grayscale.

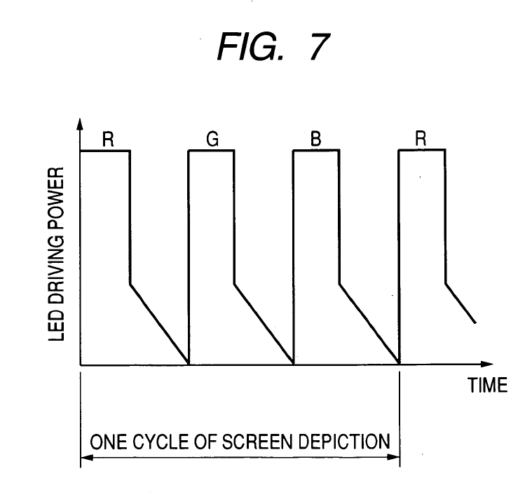

FIG. 7 shows a sixth waveform of power driving the semiconductor light emitting devices in the light source for the device shown in FIG. 1. The sixth driving-power waveform is a combination of a sawtooth waveform and a rectangular waveform. The peak values or the peak values and durations of the waveform for each of R, G, and B light are varied according to image grayscale during the period of one cycle of screen display. Driving the semiconductor light emitting devices with the sixth driving-power waveform also enables smooth grayscale display and avoiding brightness from being lost. In particular, the computing process in the image display element driving circuit can be simplified.

Incidentally, a waveform of power driving the semiconductor light emitting devices 1 in the light source array 100 is not limited to the ones shown in FIGS. 2 to 7.

1. An image display device for forming an optical image according to a video signal by directing light from a light source side to an image display element, comprising:
a light source provided with semiconductor light emitting devices to emit red light, green light, and blue light; and
a light source driving circuit which drives the light source so that a peak value of power needed to cause the semiconductor light emitting devices to emit light is varied during a period of one cycle of screen depiction;
wherein light emitted from the light source is varied in synchronization with drive of the image display element.

2. An image display device for forming an optical image according to a video signal by directing light from a light source side to an image display element, comprising;
a light source including semiconductor light emitting devices which emits red light from an LED-chip light-emitting section, a semiconductor light emitting device which emits green light from the LED-chip light-emitting section, and a semiconductor light emitting device which emits blue light from the LED-chip light-emitting section;
an image display element which modulates the emitted light by controlling amount of reflecting light from micro mirror device;
a light source driving circuit which drives the light source so that a peak value of power needed to cause each of the semiconductor light emitting devices to emit light is varied according to image grayscale during a period of one cycle of screen depiction; and
an image display element driving circuit which drives the image display element according to a video signal;
wherein light emitted from the light source is varied in synchronization with drive of the image display element.

3. The image display device according to claim 1, wherein the light source driving circuit is so constructed as to drive the semiconductor light emitting devices while varying a peak value or a peak value and duration of the power for light emission.

4. The image display device according to claim 2, wherein the light source driving circuit is so constructed as to drive the semiconductor light emitting devices while varying the peak value or the peak value and duration of the power for light emission.

5. The projection-type image display device according to claim 1, wherein the light source driving circuit is so constructed as to supply the semiconductor light emitting devices with power of a triangular waveform, a sawtooth waveform, a waveform being pointed at a top thereof and spreading at a bottom thereof, a waveform being saturated at a top thereof and spreading at a bottom thereof, or a combination of sawtooth and rectangular waveforms for driving the semiconductor light emitting devices.

6. The projection-type image display device according to claim 2, wherein the light source driving circuit is so constructed as to supply the semiconductor light emitting devices with power of a triangular waveform, a sawtooth waveform, a waveform being pointed at a top thereof and spreading at a bottom thereof, a waveform being saturated at a top thereof and spreading at a bottom thereof, or a combination of sawtooth and rectangular waveforms for driving the semiconductor light emitting devices.

7. A light source unit used in an image display device for forming an optical image according to a video signal by directing light from a light source side to an image display element, comprising:
a light source provided with semiconductor light emitting devices to emit red, green, and blue light; and
a light source driving circuit which drives the light source so that a peak value of power needed to cause each of the semiconductor light emitting devices to emit light is varied according to image grayscale during a period of one cycle of screen depiction;
wherein a light emitted from the light source is varied in synchronization with formation of optical images by the image display element.

8. The light source unit according to claim 7, wherein the light source driving circuit is so constructed as to drive the semiconductor light emitting devices while varying the peak value or the peak value and duration of the power for light-emission.

9. The light source unit according to claim 7, wherein the light source driving circuit is so constructed as to supply the semiconductor light emitting devices with power of a triangular waveform, a sawtooth waveform, a waveform being pointed at a top thereof and spreading at a bottom thereof, a waveform being saturated at a top thereof and spreading at a bottom thereof, or a combination of sawtooth and rectangular waveforms for driving the semiconductor light emitting devices.
